(19) United States
(12) Patent Application Publication
(10) Pub. No.: US 2021/0395569 A1
(43) Pub. Date: Dec. 23, 2021

(54) METHODS FOR COATING GLASS ARTICLES

(71) Applicant: CORNING INCORPORATED, Corning, NY (US)

(72) Inventors: Andrei Gennadyevich Fadeev, Elmira, NY (US); Sushmit Sunil Kumar Goyal, Painted Post, NY (US); XiaoXia He, Painted Post, NY (US); David Henry, Fontaine le Port (FR); Franklin Langlang Lee, Painted Post, NY (US)

(21) Appl. No.: 17/349,165

(22) Filed: Jun. 16, 2021

Related U.S. Application Data
(60) Provisional application No. 63/040,087, filed on Jun. 17, 2020.

(51) Int. Cl. C09D 179/08; C03C 17/00; C03C 17/32; A61J 1/14

(52) U.S. Cl. CPC C09D 179/08; A61J 1/1468; C03C 17/32; C03C 17/005

(57) ABSTRACT

A method for coating a glass article includes obtaining a glass article; selecting a coating including a fluorinated polyimide, and coating the glass article with the selected coating including the fluorinated polyimide. The fluorinated polyimide having a cohesive energy density less than or equal to 300 KJ/mol, and a glass transition temperature (T_{g}) less than or equal to 625 K.

This application claims the benefit of priority under 35 U.S.C. § 119 of U.S. Provisional Application Ser. No. 63/040,087 filed on Jun. 17, 2020, the content of which is relied upon and incorporated herein by reference in its entirety.

### BACKGROUND

### Field

The present specification generally relates to methods for coating glass articles and, more specifically, to methods for coating glass articles with a fluorinated polyimide.

### Technical Background

Glass articles are used in many applications, such as screens for electronic devices, and containers for materials including pharmaceuticals. Although glass articles have advantages, such as optical clarity, chemical durability, chemical inertness, and the like, for some applications, glass has certain drawbacks. For instance, glass may be more prone to scratches, cracks, and other damage than other materials.

To address the above, and other, concerns associated with glass articles, coatings may be used to improve various properties of a glass article. For instance, anti-frictive coatings may be applied to glass articles to decrease damage caused by contact between the glass article and another object, including—but not limited to—another glass article. In addition, coatings may be applied to a glass article during handling and then removed during subsequent process, such as sterilizing and the like. However, many different materials may be used to form coatings for glass articles, and it can be difficult to determine which materials are best situated to address a given need. Moreover, not all coating materials are compatible as coatings for all glass articles.

Accordingly, a need exists for methods of coating glass articles by determining whether coating materials are suitable before applying the coatings to the glass article.

### SUMMARY

According to a first aspect, a method for coating a glass article comprises: obtaining a glass article; selecting a coating comprising a fluorinated polyimide, the fluorinated polyimide having: a cohesive energy density less than or equal to 300 KJ/mol; and a glass transition temperature (T_{g}) less than or equal to 625 K; and coating the glass article with the selected coating comprising the fluorinated polyimide.

A second aspect includes the method for coating a glass article of the first aspect, wherein the fluorinated polyimide has a low fluorine density.

A third aspect includes the method for coating a glass article of any one of the first and second aspects, wherein a coefficient of friction of the coating comprising the fluorinated polyimide meets the following inequality:

0.27≥0.111*CED−4.319*10⁻⁴*CED²+5.594*CED³+1.135*f_{F}−5.859*10⁻²*T_{g}+5.314*T_{g}²+6.823, where CED is a cohesive energy density of the fluorinated polyimide coating, f_{F} is a number of fluorine atoms in a polymer repeat unit divided by a total number of heavy atoms in the polymer repeat unit, and T_{g} is a glass transition temperature of the fluorinated polyimide coating.

A fourth aspect includes the method for coating a glass article of any one of the first to third aspects, wherein the fluorinated polyimide has a medium fluorine density, and the fluorinated polyimide has a T_{g} less than or equal to 575 K.

A fifth aspect includes the method for coating a glass article of the fourth aspect, wherein a coefficient of friction of the coating comprising the fluorinated polyimide meets the following inequality:

0.27≥−9.017*10⁻³*CED+1.941*10⁻⁵*CED²−4.773*f_{F}+28.477*f_{F}²+2.041*10⁻³*T_{g}−2.351*10⁻⁶*T_{g}²+0.913, where CED is a cohesive energy density of the fluorinated polyimide coating, f_{F} is a number of fluorine atoms in a polymer repeat unit divided by a total number of heavy atoms in the polymer repeat unit, and T_{g} is a glass transition temperature of the fluorinated polyimide coating.

A sixth aspect includes the method for coating a glass article of any one of the first to third aspects, wherein the fluorinated polyimide coating comprises a polymer with a high fluorine density, and the fluorinated polyimide coating has a T_{g} less than or equal to 500 K.

A seventh aspect includes the method for coating a glass article of the sixth aspect, wherein a coefficient of friction of the fluorinated polyimide coating meets the following inequality:

0.27≥−5.09*10⁻⁴*CED−0.463*f_{F}+4.683*10⁻⁵*T_{g}+0.373, where CED is a cohesive energy density of the fluorinated polyimide coating, f_{F} is a number of fluorine atoms in a polymer repeat unit divided by a total number of heavy atoms in the polymer repeat unit, and T_{g} is a glass transition temperature of the fluorinated polyimide coating.

An eighth aspect includes the method for coating a glass article of any one of the first to seventh aspects, wherein the fluorinated polyimide has a solubility of less than or equal to 8.6 (cal/cm³)^{1/2}.

A ninth aspect includes the method for coating a glass article of any one of the first to eighth aspects, wherein the glass article is a glass pharmaceutical container having an interior surface and an exterior surface.

A tenth aspect includes the method for coating a glass article of the ninth aspect, wherein the step of coating the glass article with the selected coating comprising the fluorinated polyimide comprises coating at least a portion of the exterior surface of the glass pharmaceutical container.

An eleventh aspect includes the method for coating a glass article of any one of the first to tenth aspects, wherein selecting a coating comprising a fluorinated polyimide comprises: choosing an original polymer chemistry; modifying the original polymer chemistry with functional groups to generate a multitude of modified polymer chemistries; determining the cohesive energy density (CED) of each of the multitude of modified polymer chemistries; determining the T_{g} of each of the multitude of modified polymer chemistries; choosing a group of designated polymer chemistries from the multitude of modified polymer chemistries, wherein each polymer chemistry in the designated group of polymer chemistries has a CED that is less than or equal to the CED of the original polymer chemistry, and each polymer chemistry in the designated group of polymer chemistries has a T_{g} that is less than the T_{g} of the original polymer chemistry; determining the coefficient of friction of each polymer chemistry within the designated group of polymer chemistries; and choosing a selected polymer chemistry from the designated group of polymer chemistries, wherein the selected polymer chemistry has a coefficient of friction that is less than a coefficient of friction of the original polymer chemistry.

A twelfth aspect includes the method for coating a glass article of the eleventh aspect, wherein modifying the original polymer chemistry comprises: identifying a backbone structure of the original polymer chemistry, wherein the backbone structure comprises one or more attachment sites; providing a set of side chain structures; and attaching each side chain structure in the set of side chain structures to the one or more attachment sites of the backbone structure in a combinatorial fashion.

A thirteenth aspect includes the method for coating a glass article of the twelfth aspect, wherein the backbone structure incorporates a dianhydride monomer structure.

A fourteenth aspect includes the method for coating a glass article of the thirteenth aspect, wherein the dianhydride monomer structure comprises one or more member selected from the group consisting of:

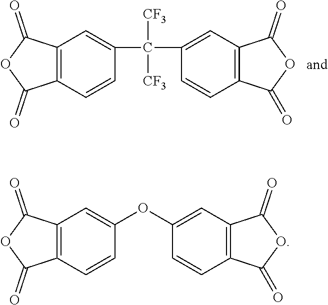 [SMILES: O=C1OC(=O)c2cc(C(c3ccc4c(c3)C(=O)OC4=O)(C(F)(F)F)C(F)(F)F)ccc21 ; "and" ; O=C1OC(=O)c2cc(Oc3ccc4c(c3)C(=O)OC4=O)ccc21]

A fifteenth aspect includes the method for coating a glass article of any the twelfth aspect, wherein the set of side chain structures comprises one or more diamines.

A sixteenth aspect includes the method for coating a glass article of the fifteenth aspect, wherein the one or more diamines comprises one or more member selected from the group consisting of:

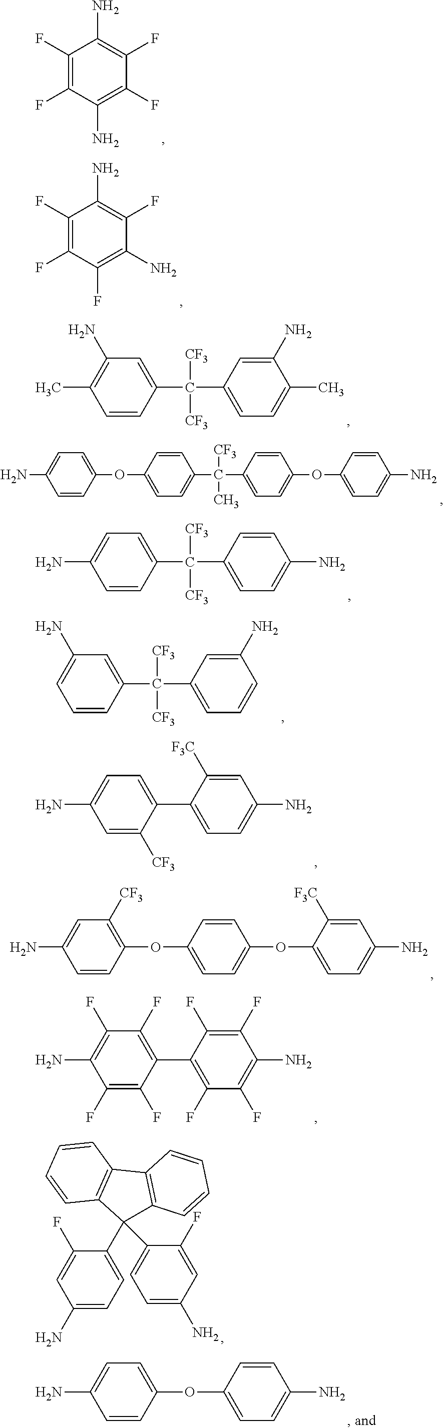

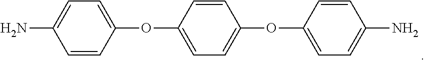 [SMILES: Nc1ccc(Oc2ccc(Oc3ccc(N)cc3)cc2)cc1 ; "."]

A seventeenth aspect includes the method for coating a glass article of the twelfth aspect, wherein the backbone structure of the original polymer chemistry is modified before attaching each side chain structure in the set of side chain structures to the one or more attachment sites of the backbone structure in a combinatorial fashion.

A, eighteenth aspect includes the method for coating a glass article of the seventeenth aspect, wherein the backbone structure of the original polymer chemistry is modified by extending the backbone structure, contracting the backbone structure, or switching chemical groups of the backbone structure.

In a nineteenth aspect a method for forming a fluorinated polyimide having a low coefficient of friction comprises: choosing an original polymer chemistry; modifying the original polymer chemistry with functional groups to generate a multitude of modified polymer chemistries; determining the cohesive energy density (CED) of each of the multitude of modified polymer chemistries; determining the T_{g} of each of the multitude of modified polymer chemistries; choosing a group of designated polymer chemistries from the multitude of modified polymer chemistries, wherein each polymer chemistry in the designated group of polymer chemistries has a CED that is less than or equal to the CED of the original polymer chemistry, and each polymer chemistry in the designated group of polymer chemistries has a T_{g} that is less than the T_{g} of the original polymer chemistry; determining the coefficient of friction of each polymer chemistry within the designated group of polymer chemistries; and forming selected polymer chemistry from the designated group of polymer chemistries, wherein the selected polymer chemistry has the lowest coefficient of friction of the designated group of polymer chemistries.

A twentieth aspect includes the method for forming a fluorinated polyimide having a low coefficient of friction of the nineteenth aspect, wherein determining the coefficient of friction of each polymer chemistry within the designated group of polymer chemistries uses the following formula:

CoF=0.111*CED−4.319*10⁻⁴*CED²+5.594*CED³+1.135*f_{F}−5.859*10⁻²*T_{g}+5.314*T_{g}²+6.823, where CED is a cohesive energy density of the fluorinated polyimide coating, f_{F} is a number of fluorine atoms in a polymer repeat unit divided by a total number of heavy atoms in the polymer repeat unit and is less than 0.1, and T_{g} is a glass transition temperature of the fluorinated polyimide coating.

A twenty first aspect includes the method for forming a fluorinated polyimide having a low coefficient of friction of the nineteenth aspect, wherein determining the coefficient of friction of each polymer chemistry within the designated group of polymer chemistries uses following formula:

CoF=−9.017*10⁻³*CED+1.941*10⁻⁵*CED²−4.773*f_{F}+28.477*f_{F}²+2.041*10⁻³*T_{g}−2.351*10⁻⁶*T_{g}²+0.913, where CED is a cohesive energy density of the fluorinated polyimide coating, f_{F} is a number of fluorine atoms in a polymer repeat unit divided by a total number of heavy atoms in the polymer repeat unit and f_{F} is greater than 0.1 and less than 0.15, and T_{g} is a glass transition temperature of the fluorinated polyimide coating.

A twenty second aspect includes the method for forming a fluorinated polyimide having a low coefficient of friction of the nineteenth aspect, wherein determining the coefficient of friction of each polymer chemistry within the designated group of polymer chemistries uses the following formula:

CoF=−5.09*10⁻⁴*CED−0.463*f_{F}+4.683*10⁻⁵*T_{g}+0.373, where CED is a cohesive energy density of the fluorinated polyimide coating, f_{F} is a number of fluorine atoms in a polymer repeat unit divided by a total number of heavy atoms in the polymer repeat unit and f_{F} is greater than 0.15, and T_{g} is a glass transition temperature of the fluorinated polyimide coating.

Additional features and advantages will be set forth in the detailed description that follows, and in part will be readily apparent to those skilled in the art from that description or recognized by practicing the embodiments described herein, including the detailed description that follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a graph showing the solubility and coefficient of friction for KAPTON® and CP1 polyimide;

FIG. 2A and FIG. 2B are flow charts of methods of computerized polymer screening according to embodiments disclosed and described herein;

FIG. 3 is a graph plotting the coefficient of friction of simulated fluorinated polyimides on the x-axis against the solubility of simulated fluorinated polyimides on the y-axis according to embodiments disclosed and described herein;

FIG. 4 is a graph plotting the cohesive energy density of fluorinated polyimides on the x-axis against the coefficient of friction of simulated fluorinated polyimides on the y-axis according to embodiments disclosed and described herein;

FIG. 5 is a graph plotting the glass transition temperature and fluorine density of fluorinated polyimides on the x-axis against the computed coefficient of friction of simulated fluorinated polyimides on the y-axis according to embodiments disclosed and described herein;

FIG. 6 is a graph plotting the simulated coefficient of friction of fluorinated polyimides on the x-axis against the predicted coefficient of friction of fluorinated polyimides on the y-axis according to embodiments disclosed and described herein;

FIG. 7 is a graph plotting the experimental coefficient of friction of fluorinated polyimides on the x-axis against the predicted coefficient of friction of fluorinated polyimides on the y-axis according to embodiments disclosed and described herein; and

FIG. 8 schematic depicts a glass container according to embodiments disclosed and described herein.

### DETAILED DESCRIPTION

Reference will now be made in detail to embodiments of methods for coating glass articles. Whenever possible, the same reference numerals will be used throughout the drawings to refer to the same or like parts. In embodiments, a method for coating a glass article comprises: obtaining a glass article; selecting a coating comprising a fluorinated polyimide, the fluorinated polyimide having: a cohesive energy density less than or equal to 300 KJ/mol; and a glass transition temperature (T_{g}) less than or equal to 625 K; and coating the glass article with the selected coating comprising the fluorinated polyimide. Various methods of firing ceramic bodies will be described herein with specific reference to the appended drawings.

Many glass articles, particularly glass pharmaceutical containers, comprise coatings. One type of coating that is particularly useful are anti-frictive coatings that decrease the coefficient of friction (CoF) of the surface of the glass article. In pharmaceutical applications, the coating assists filling operations by: (i) minimizing glass particulate generation upon contact; (ii) adding resistance to abrasion and minimizing formation of cracks at the surface of the glass article; (iii) reducing number of disruptions involved with glass-related events and improving flow of the containers in filling operations; and (iv) providing more even, consistent, and faster flow of containers through filling line, thus improving glass machinability resulting in increased line utilization and speed of filling lines.

A common coating chemistry is based on pyromellitic dianhydride-4,4′-diaminodiphenyl ether (PMDA-ODA) polyimide. One such polyimide is available as KAPTON® manufactured by DuPont. The PMDA-ODA polyimide is deposited over a tie-layer in a two-step coating process, which can lead to inefficient, time-consuming manufacturing processes. Another coating chemistry comprises a 4,4′-(hexafluoroisopropylidene) diphthalic anhydride-2,2-bis [4-(4-aminophenoxy)phenyl] hexafluoropropane (6FDA-BDAF), which is commercially available from NeXolve as CP1 polyimide. The fluorinated polymer is soluble in conventional solvents in its fully imidized state, thus allowing coating formulation that could be applied onto a glass surface in one step, which significantly improves economics of the coating process. However, the CoF of a PMDA-ODA-based polyimide is from 0.19 to 0.2, while a 6FDA-BDAF-based coating has a CoF of about 0.27. The increase in the CoF between the PMDA-ODA-based polyimide and the 6FDA-BDAF-based coating causes a decrease in coating machinability value proposition. Accordingly, a need exists for coatings with decreases CoF that can be applied in a single step.

However, formulation and characterization of new coating chemistries is time consuming and resource intensive due to limited availability of fluorinated polyimides, the large chemistry space, and the costly procurement and synthesis procedures. In addition, it can take weeks to formulate and test different coatings. In this disclosure, methods for coating glass articles with coatings comprising fluorinated polyimides that do not require intensive formulation and testing are provided.

Traditionally, it has been difficult to measure the CoF of a coating for glass articles without formulating and manufacturing the coating, applying it to a glass article, and testing the CoF of the coating after it has been applied to the glass article. This process is time consuming and requires a significant amount of resources. Further, this process must be completed a number of times to test coatings of different chemistries. Accordingly, time, resources, and cost could be saved it a correlation between known and well-recorded properties of materials and the CoF of the materials could be made. Through various studies and modeling that are described in more detail in this disclosure, a relationship between CoF and the following three parameters was discovered: (1) cohesive energy density (CED); (2) glass transition temperature (T_{g}); and fluorine density (M. The CED is an amount of energy needed to remove a unit volume of molecules from adjacent molecules to achieve infinite separation. In the condensed phase, the CED is equal to the heat of vaporization of the compound divided by its molar volume. As used herein, the fluorine density is the number of fluorine atoms in a polymer repeat unit divided by the total number of heavy atoms in the polymer repeat unit. A “heavy atom” as used herein refers to any atom other than hydrogen (H), and a repeat unit is a representative chemical structure that links together many times to constitute an overall polymer structure (e.g., polyethylene has a C₂H₂ repeat unit).

In view of these studies, it has unexpectedly been found that fluorinated polyimide coatings having certain combinations of CED, T_{g}, and fluorine density will have a CoF that is less than traditional polyimide coatings that can be applied in a single step. The above correlations allow one to select a fluorinated polyimide coating having a low CoF without the need to run costly and time-consuming tests by selecting a fluorinated polyimide having combinations of CED, T_{g}, and fluorine density as disclosed hereinabove. Methods for obtaining these correlations and selecting a fluorinate polyimide will now be described.

Initially a multitude of parameters—also referred to herein as “motifs”—were tested to determine a correlation between the motifs and CoF. Such motifs include: structural elements, such as fluorine distribution, number of rings, and rigidity; material characteristics, such as Hilebrand (VK)-solubility, CED, and T_{g}; topographical, such as surface roughness, polymer-polymer interpenetration, and surface area; and thermodynamics, such as Van der Waal and hydrogen bonding interactions, charge-charge interactions, and surface energy. In-silico characterization methods were developed to analyze the various motifs and their effects on the CoF. After significant analysis of simulated and formulated fluorinated polyimides, it was found that most motifs did not have any correlation with CoF, such as polymer interpenetration, surface area, Van der Waal interaction, coulombic interaction, surface energy, orientation, fluorine content, and density. However, through this analysis, it was unexpectedly determined that CED, T_{g}, and fluorine density did have a correlation to CoF. Nothing in the literature prior to this disclosure indicated the correlation between CoF, CED, T_{g}, and fluorine density. However, CED measures the attraction between adjacent polymer chains and, thus, it is expected that as the CED increases, polymer chains react more strongly at the interface causing CoF to increase. Likewise, as T_{g} increases, the relative dissipation of energy by the polymer at room temperature decreases, which would be expected to cause the CoF to increase. From this knowledge, fluorinated polyimides having low CED and low T_{g} can be explored and manipulated to achieve a coating that can be applied in a single application and still have a low CoF.

As disclosed herein above, fluorinated polyimides having low CED and T_{g} would be expected to have a low CoF. Accordingly, when choosing a small number of fluorinated polyimides for further analysis from the hundreds of thousands of known fluorinated polyimides, fluorinated polyimides have a CED that is less than or equal to the CED of known low-CoF coatings were selected. This selection can significantly decrease the number of fluorinated polyimides to be evaluated from hundreds of thousands, to merely hundreds. However, even evaluating hundreds of fluorinated polyimide chemistries could take months. Therefore, the hundreds of fluorinated polyimides with a low CED can be further reduced by selecting from this group of fluorinated polyimides the polyimides with a T_{g} that is less than or equal to the T_{g} of known low-CoF coatings. After making this selection, the hundreds of fluorinated polyimides with low CED is further reduced to tens of fluorinated polyimides having the combination of low CED and low T_{g}. Analyzing and modifying tens of fluorinated polyimides can take only a couple of weeks to a month. In this way, resources can be spend studying fluorinated polyimides having the highest likelihood of resulting in a low-CoF coating.

Fluorinated polyimides selected as having a low CED and low T_{g} can then be analyzed and manipulated to select a fluorinated polyimide to use in a low-CoF coating. According to embodiments disclosed and described herein, selecting a coating comprising a fluorinated polyimide comprises: choosing an original polymer chemistry; modifying the original polymer chemistry with functional groups to generate a multitude of modified polymer chemistries; determining the cohesive energy density (CED) of each of the multitude of modified polymer chemistries; determining the Tg of each of the multitude of modified polymer chemistries; choosing a group of designated polymer chemistries from the multitude of modified polymer chemistries, wherein each polymer chemistry in the designated group of polymer chemistries has a CED that is less than or equal to the CED of the original polymer chemistry, and each polymer chemistry in the designated group of polymer chemistries has a Tg that is less than the Tg of the original polymer chemistry; determining the coefficient of friction of each polymer chemistry within the designated group of polymer chemistries; and choosing a selected polymer chemistry from the designated group of polymer chemistries, wherein the selected polymer chemistry has the lowest coefficient of friction of the designated group of polymer chemistries. This method is elaborated with specific polymers below.

Two known low CoF coating materials are KAPTON® available from DuPont™ and CP1 polyimide available from Nexolve, and will be used to describe embodiments for modifying the polymers disclosed and described herein. According to this embodiment, KAPTON® and CP1 polyimide are referred to as the “original polymer chemistry.” This original polymer chemistry can be modified by replacing hydrogen atoms with functional groups or by replacing side chains with loosely bonded functional groups (such as alkyl groups, for example) with different functional groups via in-silico simulations. The polymers with altered side chains are referred to as “modified polymer chemistries.” Through in-silico processes described in further detail below, the CED and T_{g} of each of the modified polymer chemistries are determined.

According to embodiments, a backbone structure with at least one attachment site and at least one side chain structure is manipulated by combinatorically attaching each side chain structure to each attachment site. In embodiments, the backbone comprises any arbitrary number of attachment sites and the side chain structures comprises any arbitrary number of side chain structures. In one or more embodiments, each side chain structure is combinatorically attached to each attachment site (e.g., if there are 4 attachment sites and 10 different side chain structures, then 10⁴ or 10,000 distinct polymer structures would be generated). It should be understood that in embodiments not every possible polymer structure is generated. In embodiments, the backbone structure itself may be modified by extending the backbone structure, contracting the backbone structure, or by changing out chemical groups. Changing out the chemical groups are done by designating a site along the backbone structure where a substitution may occur and then inserting different functional groups from a library of functional atoms (such as, for example, fluorine) and groups (such as, for example, phenyl) at that point along the backbone structure to determine what can be substitute on that site. For example, the hydrogen atoms along the backbone structure may individually be substituted with the various functional atoms and groups in the library of functional atoms and groups to form a collection of new polymers. An empirical model was used to calculate the cohesive energy densities of these potential candidates. This model takes a simplified molecular-input line-entry system (SMILES) string as an input and interprets the corresponding molecular structure as a graph, where atoms are nodes and bonds between atoms are edges. The SMILES string is a linguistic construct that represents the connectivity between all of the atoms in a given molecule. From the graph, certain descriptors are derived (e.g., numbers of certain functional groups) to provide an interpretable feature set for the calculation.

A group of designated polymer chemistries is selected from the multitude of modified polymer chemistries, where each polymer chemistry in the designated polymer chemistry has a CED that is less than or equal to the CED of the original polymer chemistry and each polymer chemistry in the designated polymer chemistry has a T_{g} that is less than or equal to the T_{g} in the original polymer chemistry. The fluorinated polyimides from the group of designated polymer chemistries are then analyzed in-silico to determine the CoF of each of the fluorinated polyimides within the designated polymer chemistries. Table 1 below shows results of this process for the KAPTON® and CP1 polyimide original chemistries, where the variant with the lowest CoF and the variant with the highest CoF are shown. As Table 1 exemplifies, the KAPTON® variant with the lowest CoF, which adds two fluorine atoms to the benzene ring of the original KAPTON® chemistry, is 5% lower than the original KAPTON® polymer chemistry. The highest CoF variant, which added two benzene rings to the KAPTON® original chemistry, is 17% higher than the original KAPTON® polymer chemistry. Similarly, Table 1 shows that the CP1 polyimide variant with the lowest CoF, which added two fluorine atoms to the benzene ring of the CP1 polyimide original chemistry, was 14% lower than the CP1 polyimide original polymer chemistry. The CP1 polyimide variant with the highest CoF, which added two benzene rings to the CP1 polyimide original chemistry, was 1% higher than the CP1 polyimide original chemistry. Although the variants of the designated polymer having the lowest CoF is desirable from a performance standpoint, it should be understood that other variants of the designated polymers not having the lowest CoF can be used based on cost, manufacturing conditions, or the like.

TABLE 1

| | Low CoF | High CoF |
|---|---|---|
| Original Polymer | Variant | Variant |
| Kapton ® | −5% | +17% |
| (% change CoF) | | |
| CP1 | −14% | +1% |
| (% change CoF) | | |

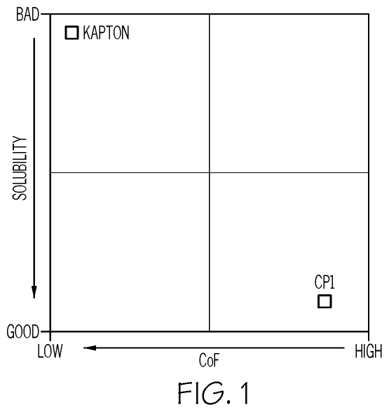

The methods disclosed and described herein can be used to not only determine the CoF of fluorinated polyimide-containing coatings, but can also be used with multiple variables. For instance, solubility of the fluorinated polyimide can affect how easily the fluorinate polyimide can be applied to a substrate. Accordingly, embodiments disclosed and described herein can be used to formulate a fluorinated polyimide having a good combination of CoF and solubility. As an example, KAPTON® has low CoF but a large difference between the solubility parameter of the polymer and the solvent, while CP1 polyimide has a low difference between the solubility parameter of the polymer and the solvent, but relatively poor CoF, as shown in FIG. 1.

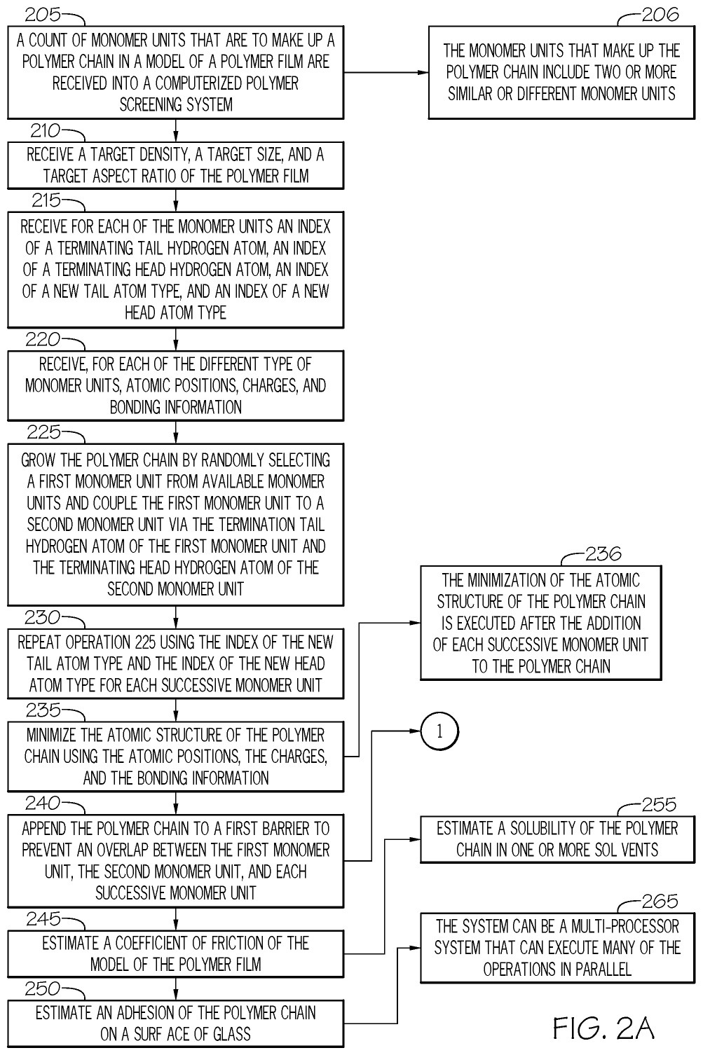

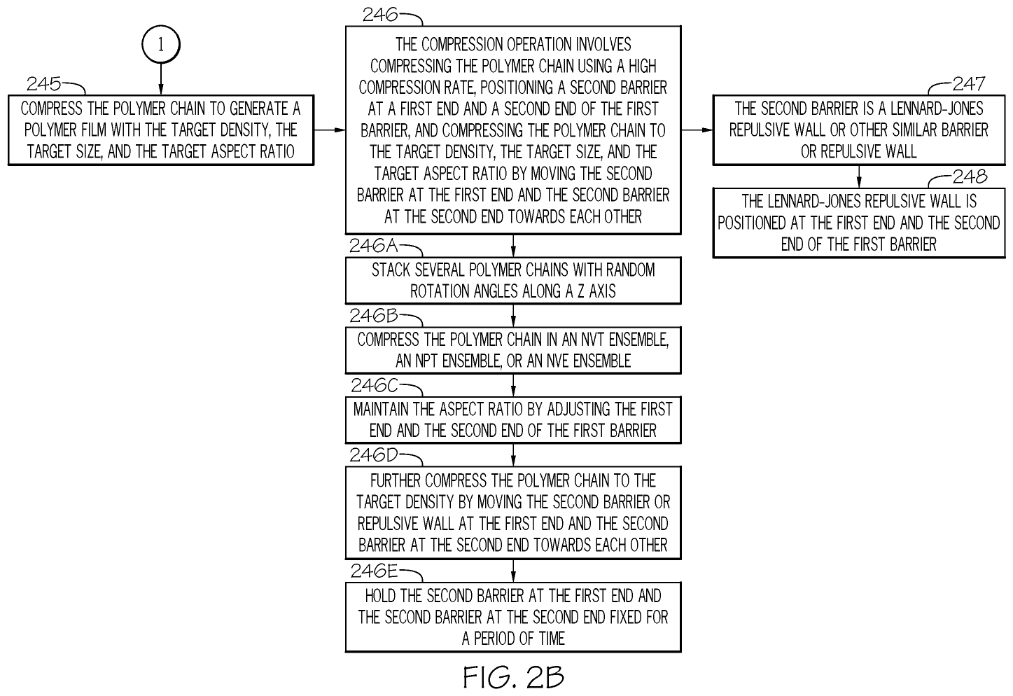

FIGS. 2A and 2B are block diagrams illustrating operations and features of a computerized polymer screening system and method. FIGS. 2A and 2B include a number of blocks 205-265. Though arranged substantially serially in the embodiments shown in FIGS. 2A and 2B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now to FIGS. 2A and 2B, at 205, a count, number or amount of monomer units that are to make up a polymer chain in a model of a polymer film are received into a computerized polymer screening system. The number of monomer units that make up the modeled polymer chain can range from only a few (e.g., three or four) to several dozen or so. As indicated at 206, the monomer units that make up the polymer chain in the model of the polymer film can include two or more similar or different monomer units, thereby rendering a copolymer. The modeled polymer chain can also of course be a homopolymer. An example file includes the names of the desired polymer films, the number of monomer units per the chains that make up the polymer film, and the density (operation 210) of the desired polymer film.

At 210, the computerized polymer screening system receives a target density, a target size, and a target aspect ratio of the soon to be modeled polymer film, and at 215, the system receives for each of the monomer units, an index of a terminating tail hydrogen atom, an index of a terminating head hydrogen atom, an index of a new tail atom type, and an index of a new head atom type. As noted at 206, the modeled polymer chain can be a homopolymer or a copolymer. If the modeled chain is a homopolymer, the indices of the terminating tail hydrogen atom, the terminating head hydrogen atom, the new tail atom type, and the new head atom type will apply to each of the single monomer unit. If the modeled chain is a co-polymer, an index of the terminating tail hydrogen atom, the index of the terminating head hydrogen atom, the index of the new tail atom type, and the index of a new head atom type are received for each different type of monomer unit. At 220, the system further receives, for each of the different type of monomer units, atomic positions, charges, and bonding information.

At operation 225, the system grows the polymer chain by randomly selecting a first monomer unit from the plurality of available monomer units, which were input into the computerized system, and couples the first monomer unit to a second monomer unit via the termination tail hydrogen atom of the first monomer unit and the terminating head hydrogen atom of the second monomer unit. As indicated at 230, the operation of 225 is repeated using the index of the new tail atom type and the index of the new head atom type for each successive monomer unit. This repetition grows the polymer chain until the length of the chain is equal to the count of the monomer units that was identified in operation 205.

At 235, the atomic structure of the modeled polymer chain is minimized using the atomic positions, the charges, and the bonding information. The result of this minimization is that the bond lengths, bond angles, dihedrals, and impropers of the polymer chain are correctly assigned, that is, that atomic bonding occurs at known bond distances, angles, etc. This operation ensures that these correctly assigned structures are obtained when generating the polymer atomic structure. This is done by assigning a force field, which is a representation that provides the energy of the system given its current spatial-chemical arrangement. The force field essentially is a look up table that contains a list of these atom types and the nominal values for the correct bonding, angle, and dihedral numbers, and the associated energy function that describes how the energy changes as the bond, angle, dihedral, etc. change. The force field itself is publicly available. In short, for the given bond lengths and angles, the force field contains the reference bond lengths and angles, which allows for a comparison to be made and the structure is optimized by minimizing this energy value reported by using the force field. As indicated at 236, the minimization of the atomic structure of the polymer chain is executed after the addition of each successive monomer unit to the polymer chain.

At 240, the polymer chain is appended to a first barrier to prevent an overlap between the first monomer unit, the second monomer unit, and each successive monomer unit. Such a first barrier can be a 3D periodic box.

At 245, the system compresses the polymer chain to generate the model of the polymer film that has the previously selected target density, the target size, and the target aspect ratio. As illustrated at 246, the compression operation involves compressing the polymer chain using a high compression rate. As previously noted, the compression rate should be approximately 0.04 Å/fs, but ideally should be allowed to go as low as computation overhead allows. The compression operation further involves positioning a second barrier at a first end and a second end of the first barrier (e.g., a periodic box), and compressing the polymer chain to the target density, the target size, and the target aspect ratio by moving the second barrier at the first end and the second barrier at the second end towards each other. As indicated at 247, the second barrier can be a Lennard-Jones repulsive wall or other similar barrier or repulsive wall. In a particular example, for example when the barrier or repulsive wall is a Lennard-Jones repulsive wall, the Lennard-Jones repulsive wall is positioned at the first end and the second end of the first barrier (e.g., periodic box) (248). This positioning of the Lennard-Jones repulsive wall breaks a first barrier boundary condition and forms the model of the polymer film. In an embodiment, when the second barrier is a repulsive wall, or in particular a Lennard-Jones repulsive wall, the Lennard-Jones repulsive wall can be formulated as follows:

$$E = ɛ [ \frac{2}{15} {( \frac{σ}{γ} )}^{9} - {( \frac{σ}{γ} )}^{3} ] , r < {τ}_{c}$$

In the above formulation, ε is a potential energy scale between the wall and any polymer atoms (set to be 1.0 Kcal/mole), σ is a length scale between the wall and any polymer atoms (set to be 1.0 Å), y is a potential cutoff between the wall and any polymer atoms (set to be 1.2 Å), rr is the bond distance, and τ_{c} is the cut-off distance up to which the repulsive potential is applied. The first derivative of the formula gives the force between the wall and any polymer atoms. The parameters are set up in the way that polymer atoms will undergo huge repulsive force if they get too close to the wall (<=1.2 Å).

The compression of the polymer chain using a high compression rate includes several operations. First, as indicated at 246A, the system stacks several of the polymer chains with random rotation angles along a z-axis. This creates an initial open bulk polymer chain structure. Then, at 246B, the system compresses the polymer chain in an NVT ensemble, an NPT ensemble, or an NVE ensemble until reaching approximately 75% of the target density. At 246C, the system maintains the aspect ratio by adjusting the first end and the second end of the first barrier. Maintaining the aspect ratio involves maintaining the ratio between the x/y and z dimensions of the system. Since the interaction between atoms is periodic in the x/y, there can be a tendency for the system to spread out in x/y, and so to restrict this the ratio with the z-dimension is maintained to ensure that the films have a certain thickness to it. Lastly, at 246D, the polymer chain is further compressed to the target density by moving the second barrier or repulsive wall at the first end and the second barrier at the second end towards each other. In another embodiment, as indicated at 246E, the system holds the second barrier at the first end and the second barrier at the second end fixed for a period of time. This holding of the second barrier relaxes the polymer chain and forms the model of the polymer film.

The system, after the compressions are completed, at 250, estimates a coefficient of friction of the model of the polymer film. In another embodiment, as indicated at 255, the system estimates a solubility of the polymer chain in one or more solvents, and at 260, the system estimates an adhesion of the polymer chain on a surface of glass. The adhesion of the compressed polymer film is the energy that can hold these polymer chains together, which can be calculated by the total energy of the system minus the energy of each single chain. The total system and single chain energy are computed using the force field. Every bond distance, bond angle, dihedral, and improper contributes to some energy component, which is added up to indicate the energy. Solubility of the polymer is calculated using the Hilderbrand & Scott formula, which uses the adhesion energy density as a metric for solubility. The adhesion energy density is the adhesion of the compressed polymer film per volume.

As noted at 265, the system can be a multi-processor system that can execute many of the operations in parallel. Specifically, the operations of growing the polymer chain (225), minimizing an atomic structure of the polymer chain (235), appending the polymer chain to a first barrier (240), compressing the polymer chain (245), and estimating a coefficient of friction of the model of the polymer film can be executed in parallel (250). More particularly, a Python file can include a parameter that determines the number of parallel processes that will be executed.

To determine formulations having a low CoF and a good solubility, multiple polymer and copolymer chemistries were simulated according to embodiments disclosed and described herein. According to embodiments, it was found that backbone structures of polyimides that incorporate at least one dianhydride monomer structure provided a combination of low CoF and good solubility. According to embodiments, the dianhydride monomer structure incorporated into the backbone structure of polyimides is selected from the group consisting of

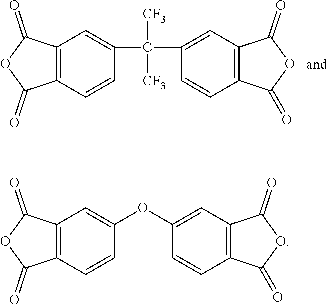 [SMILES: O=C1OC(=O)c2cc(C(c3ccc4c(c3)C(=O)OC4=O)(C(F)(F)F)C(F)(F)F)ccc21 ; "and" ; O=C1OC(=O)c2cc(Oc3ccc4c(c3)C(=O)OC4=O)ccc21]

In one or more embodiments, it was found that side chain structures comprising one or more diamine(s) provides a fluorinated polyimide comprising low CoF and good solubility. In embodiments, the one or more diamine is selected from the group consisting of

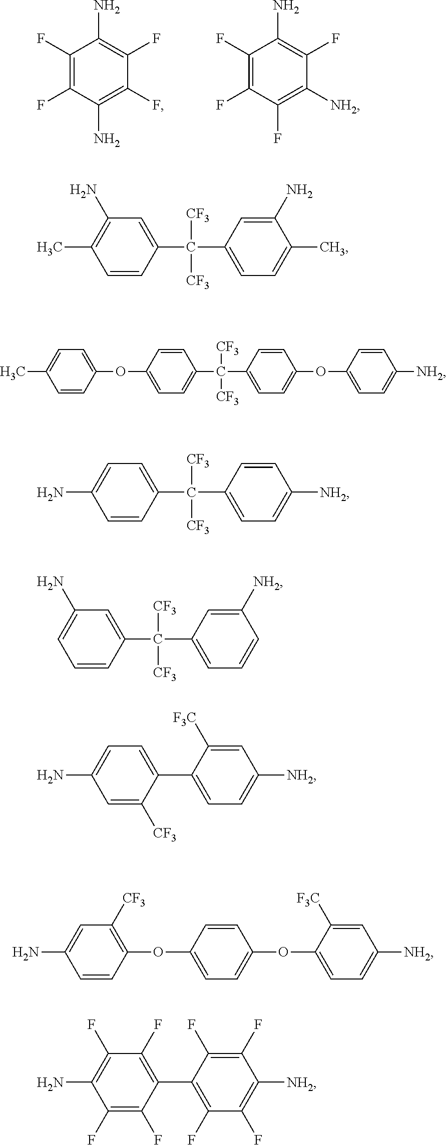

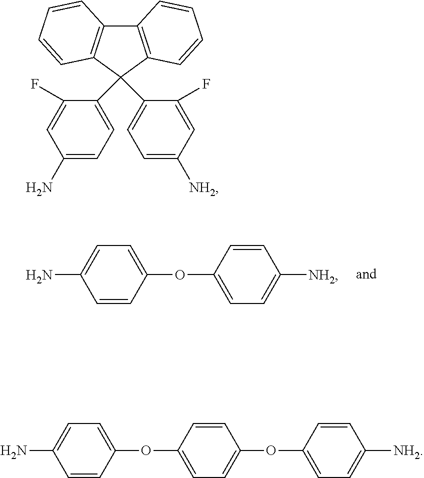 [SMILES: Nc1ccc(C2(c3ccc(N)cc3F)c3ccccc3-c3ccccc32)c(F)c1 ; Nc1ccc(Oc2ccc(N)cc2)cc1 ; Nc1ccc(Oc2ccc(Oc3ccc(N)cc3)cc2)cc1]

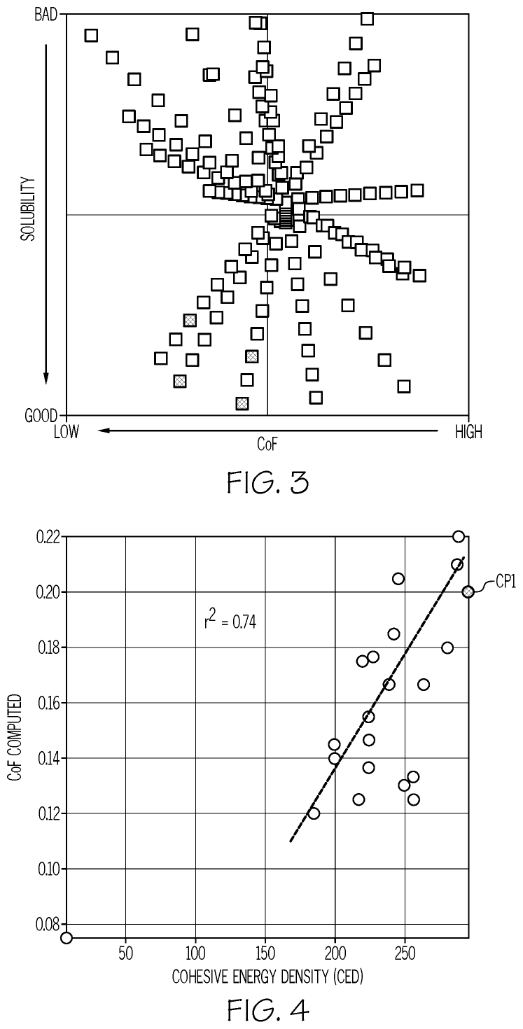

To determine which fluorinated polyimides have the best combination of CoF and solubility, backbone structures of polyimides incorporating the dianhydrides shown above were combinatorically substituted wherever hydrogens were attached to aromatic carbons with the functional groups comprising the diamines shown above to form one hundred forty (140) polymer chemistries using the methods disclosed and described herein. The CoF and difference in the solubility parameter of the polymer and the solvent of each of these chemistries is graphically shown in FIG. 3. From this, data coatings comprising fluorinated polyimides having a combination of low CoF and good solubility.

Using the methods disclosed and described herein, the CED, T_{g}, fluorine density, and CoF of numerous fluorinated polyimides can be evaluated at little cost and in little time. Simulating, analyzing, and graphing the data from the numerous fluorinated polyimides provided values for CED, T_{g}, and fluorine density that results in a low CoF coating.

FIG. 4 shows the CED of various fluorinated polyimide coatings on the x-axis plotted against the computed CoF of the fluorinated polyimide coatings on the y-axis. As show in FIG. 4, the CED of CP1 polyimide is about 300 kilojoules per mole (KJ/mol). However, using the methods disclosed and described herein, a number of fluorinated polyimides having a CED less than 300 KJ/mol have been shown to provide a lower CoF than CP1 polyimide. In embodiments, the CED of fluorinated polyimides used as coatings is less than or equal to 290 KJ/mol, such as less than or equal to 280 KJ/mol, less than or equal to 270 KJ/mol, less than or equal to 260 KJ/mol, less than or equal to 250 KJ/mol, less than or equal to 240 KJ/mol, less than or equal to 230 KJ/mol, less than or equal to 220 KJ/mol, less than or equal to 210 KJ/mol, or less than or equal to 200 KJ/mol. In embodiments, fluorinated polyimides have a CED that is greater than or equal to 150 KJ/mol and less than or equal to 300 KJ/mol, such as greater than or equal to 150 KJ/mol and less than or equal to 290 KJ/mol, greater than or equal to 150 KJ/mol and less than or equal to 280 KJ/mol, greater than or equal to 150 KJ/mol and less than or equal to 270 KJ/mol, greater than or equal to 150 KJ/mol and less than or equal to 260 KJ/mol, greater than or equal to 150 KJ/mol and less than or equal to 250 KJ/mol, greater than or equal to 150 KJ/mol and less than or equal to 240 KJ/mol, greater than or equal to 150 KJ/mol and less than or equal to 230 KJ/mol, greater than or equal to 150 KJ/mol and less than or equal to 220 KJ/mol, greater than or equal to 150 KJ/mol and less than or equal to 210 KJ/mol, greater than or equal to 150 KJ/mol and less than or equal to 200 KJ/mol, greater than or equal to 150 KJ/mol and less than or equal to 190 KJ/mol, greater than or equal to 150 KJ/mol and less than or equal to 180 KJ/mol, greater than or equal to 150 KJ/mol and less than or equal to 170 KJ/mol, or greater than or equal to 150 KJ/mol and less than or equal to 160 KJ/mol.

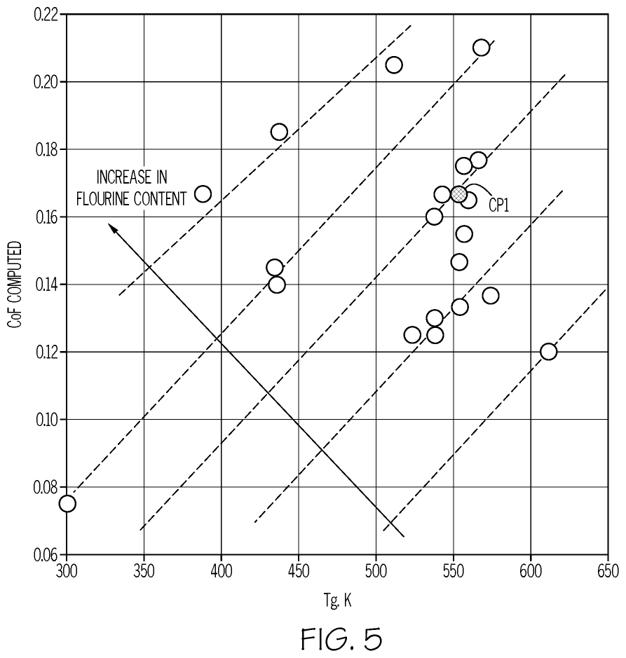

FIG. 5 shows the T_{g} of various fluorinated polyimide coatings on the x-axis plotted against the computed CoF of the fluorinated polyimide coatings on the y-axis. Using the methods disclosed and described herein, a number of fluorinated polyimides having various T_{g} values have been shown to provide a lower CoF than CP1 polyimide. The T_{g} of fluorinated polyimides used as coatings, according to embodiments, is less than or equal to 625 K, such as less than or equal to 615 K, less than or equal to 610 K, less than or equal to 600 K, less than or equal to 590 K, less than or equal to 580 K, less than or equal to 570 K, less than or equal to 560 K, less than or equal to 550 K, less than or equal to 540 K, less than or equal to 530 K, less than or equal to 520 K, less than or equal to 510 K, less than or equal to 500 K, less than or equal to 490 K, less than or equal to 480 K, less than or equal to 470 K, less than or equal to 460 K, or less than or equal to 450 K. In embodiments, the T_{g} of fluorinated polyimides used as coatings is greater than or equal to 350 K and less than or equal to 625 K, such as greater than or equal to 360 K and less than or equal to 615 K, greater than or equal to 350 K and less than or equal to 610 K, greater than or equal to 350 K and less than or equal to 600 K, greater than or equal to 350 K and less than or equal to 590 K, greater than or equal to 350 K and less than or equal to 580 K, greater than or equal to 350 K and less than or equal to 570 K, greater than or equal to 350 K and less than or equal to 560 K, greater than or equal to 350 K and less than or equal to 550 K, greater than or equal to 350 K and less than or equal to 540 K, greater than or equal to 350 K and less than or equal to 530 K, greater than or equal to 350 K and less than or equal to 520 K, greater than or equal to 350 K and less than or equal to 510 K, greater than or equal to 350 K and less than or equal to 500 K, greater than or equal to 350 K and less than or equal to 490 K, greater than or equal to 350 K and less than or equal to 480 K, greater than or equal to 350 K and less than or equal to 470 K, greater than or equal to 350 K and less than or equal to 460 K, greater than or equal to 350 K and less than or equal to 450 K, greater than or equal to 350 K and less than or equal to 440 K, greater than or equal to 350 K and less than or equal to 430 K, greater than or equal to 350 K and less than or equal to 420 K, greater than or equal to 350 K and less than or equal to 410 K, greater than or equal to 350 K and less than or equal to 400 K, greater than or equal to 350 K and less than or equal to 390 K, greater than or equal to 350 K and less than or equal to 380 K, greater than or equal to 350 K and less than or equal to 370 K, or greater than or equal to 350 K and less than or equal to 360 K.

It should be appreciated that embodiments of fluorinated polyimide coatings disclosed and described herein may have any combination of the CED and T_{g} described hereinabove. According to methods of embodiments, a coating comprising a fluorinated polyimide having a combination of CED and T_{g} disclosed and described herein is selected and coated onto an obtained glass article. The coating may be conducted by a suitable method, such as spray coating, dip coating, jet coating, spin coating, coating with a brush, or the like.

It has also been found that the CoF of fluorinated polyimide containing coatings can be further refined by the fluorine density of the fluorinated polyimide containing coatings. FIG. 5 also shows the fluorine density of various fluorinated polyimide coatings (diagonal dashed lines). As show in FIG. 5 as the fluorine density of the fluorinated polyimide increases, the CoF generally increases, which generally means that lower T_{g} values are required to provide low CoF. Accordingly, it was found that the higher the fluorine density of a polymer, the lower the T_{g} is required to be to provide a low CoF.

Using the fluorine density, the CoF of fluorinated polyimide containing coatings can be categorized into at least three groups: (1) low fluorine density; (2) medium fluorine density; and (3) high fluorine density. In embodiments, fluorinated polyimides having a low fluorine density comprises fluorinated polyimides have a fluorine density less than 0.10 (f_{F}<0.10), fluorinated polyimides having a medium fluorine density comprises fluorinated polyimides have a fluorine density greater than or equal to 0.10 and less than or equal to 0.15 (0.10≤f_{F}≤0.15), and fluorinated polyimides having a high fluorine density comprises fluorinated polyimides have a fluorine density greater than 0.15 (f_{F}>0.15). Within each of these fluorine density groups, the relationship between CED and T_{g} of the fluorinated polyimide and the CoF of the fluorinated polyimide coating has been determined. Thus, for each of the fluorine density groups a fluorinated polyimide may be selected based on the CED and T_{g} of the fluorinated polymer to achieve a desirably low CoF.

From the methods disclosed and described herein, such as the information shown in FIG. 5, a correlation between CoF and T_{g}, fluorine density, and CED was evaluated for the data obtained from atomistic simulations. Combining the information collected from simulations, and experiments the following correlations were discovered.

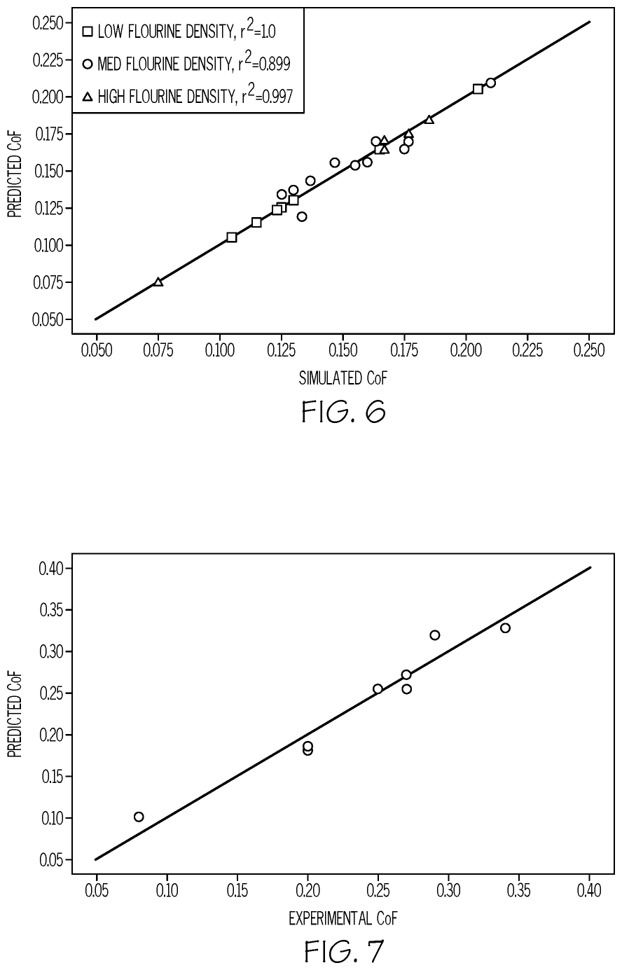

According to embodiments, the fluorinated polyimide used in the fluorinated polyimide containing coating for a glass article has a low fluorine density. With reference now to FIG. 6, a linear regression was formulated for simulated CoF using CED, T_{g}, and f_{F} of numerous fluorinated polyimides evaluated according to methods disclosed and described herein. For instance, as shown in FIG. 6, the simulated CoF according to embodiments disclosed and described herein is plotted on the x-axis against the predicted CoF on the y-axis. As used herein, the predicted CoF is the CoF that is calculated using the derived regression equations (such as those shown below). The simulated CoF is the CoF that is calculated using molecular dynamics simulation. In one or more embodiments, the CoF of a coating comprising a fluorinated polyimide having a low fluorine density is related to the CED and T_{g} by the following equation:

CoF=0.111*CED−4.319*10⁻⁴*CED²+5.594*CED³+1.135*f_{F}−5.859*10⁻²*T_{g}+5.314*T_{g}²+6.823.

As shown in FIG. 6, the regression analysis (r²) for this equation is equal to 1.000.

In one or more embodiments disclosed and described herein the CoF of the coating comprising a fluorinated polyimide having a low fluorine density is less than or equal to 0.27, such that the above equation can be written as the following inequality:

0.27≥−0.111*CED−4.319*10⁻⁴*CED²+5.594*CED³+1.135*f_{F}−5.859*10⁻²*T_{g}+5.314*T_{g}²+6.823.

In embodiments, the CoF of the coating comprising the fluorinated polyimide having a low fluorine density is less than or equal to 0.26, such as less than or equal to 0.25, less than or equal to 0.24, less than or equal to 0.23, less than or equal to 0.22, less than or equal to 0.21, or less than or equal to 0.20. In embodiments, the CoF of the coating comprising the fluorinated polyimide having a low fluorine density is less than or equal to 0.27 and greater than or equal to 0.10, such as less than or equal to 0.26 and greater than or equal to 0.10, less than or equal to 0.25 and greater than or equal to 0.10, less than or equal to 0.24 and greater than or equal to 0.10, less than or equal to 0.23 and greater than or equal to 0.10, less than or equal to 0.22 and greater than or equal to 0.10, less than or equal to 0.21 and greater than or equal to 0.10, or less than or equal to 0.20 and greater than or equal to 0.10.

According to embodiments, the fluorinated polyimide in the fluorinated polyimide containing coating for a glass article has a medium fluorine density and a T_{g} that is less than or equal to 575 K. With reference now to FIG. 6, a linear regression was formulated for simulated CoF using CED, T_{g}, and f_{F} of numerous fluorinated polyimides evaluated according to methods disclosed and described herein. For instance, as shown in FIG. 6, the simulated CoF according to embodiments disclosed and described herein is plotted on the x-axis against the predicted CoF on the y-axis. In one or more embodiments, the CoF of a coating comprising a fluorinated polyimide having a medium fluorine density and a T_{g} that is less than or equal to 575 K is related to the CED and T_{g} by the following equation:

CoF=−9.017*10⁻³*CED+1.941*10⁻⁵*CED²−4.773*f_{F}+28.477*f_{F}²+2.041*10⁻³*T_{g}−2.351*10⁻⁶*T_{g}²+0.913.

As shown in FIG. 6, the r² for this equation is 0.899.

In one or more embodiments disclosed and described herein the CoF of the coating comprising a fluorinated polyimide having a medium fluorine density and a T_{g} that is less than or equal to 575 K is less than or equal to 0.27, such that the above equation can be written as the following inequality:

0.27≥−9.017*10⁻³*CED+1.941*10⁻⁵*CED²−4.773*f_{F}+28.477*f_{F}²+2.041*10⁻³*T_{g}−2.351*10⁻⁶*T_{g}²+0.913.

In embodiments, the CoF of the coating comprising the fluorinated polyimide having a medium fluorine density and a T_{g} that is less than or equal to 575 K is less than or equal to 0.26, such as less than or equal to 0.25, less than or equal to 0.24, less than or equal to 0.23, less than or equal to 0.22, less than or equal to 0.21, or less than or equal to 0.20. In embodiments, the CoF of the coating comprising the fluorinated polyimide having a medium fluorine density and a T_{g} that is less than or equal to 575 K is less than or equal to 0.27 and greater than or equal to 0.10, such as less than or equal to 0.26 and greater than or equal to 0.10, less than or equal to 0.25 and greater than or equal to 0.10, less than or equal to 0.24 and greater than or equal to 0.10, less than or equal to 0.23 and greater than or equal to 0.10, less than or equal to 0.22 and greater than or equal to 0.10, less than or equal to 0.21 and greater than or equal to 0.10, or less than or equal to 0.20 and greater than or equal to 0.10.

According to embodiments, the fluorinated polyimide in the fluorinated polyimide containing coating for a glass article has a high fluorine density and a T_{g} that is less than or equal to 500 K. With reference now to FIG. 6, a linear regression was formulated for simulated CoF using CED, T_{g}, and f_{F} of numerous fluorinated polyimides evaluated according to methods disclosed and described herein. For instance, as shown in FIG. 6, the simulated CoF according to embodiments disclosed and described herein is plotted on the x-axis against the predicted CoF on the y-axis. In one or more embodiments, the CoF of a coating comprising a fluorinated polyimide having a high fluorine density and a T_{g} that is less than or equal to 500 K is related to the CED and T_{g} by the following equation:

CoF=−5.09*10⁻⁴*CED−0.463*f_{F}+4.683*10⁻⁵*T_{g}+0.373.

As shown in FIG. 6, the r² for this equation is 0.997.

In one or more embodiments disclosed and described herein the CoF of the coating comprising a fluorinated polyimide having a high fluorine density and a T_{g} that is less than or equal to 500 K is less than or equal to 0.27, such that the above equation can be written as the following inequality:

0.27≥−5.09*10⁻⁴*CED−0.463*f_{F}+4.683*10⁻⁵*T_{g}+0.373.

In embodiments, the CoF of the coating comprising the fluorinated polyimide having a high fluorine density and a T_{g} that is less than or equal to 500 K is less than or equal to 0.26, such as less than or equal to 0.25, less than or equal to 0.24, less than or equal to 0.23, less than or equal to 0.22, less than or equal to 0.21, or less than or equal to 0.20. In embodiments, the CoF of the coating comprising the fluorinated polyimide having a high fluorine density and a T_{g} that is less than or equal to 500 K is less than or equal to 0.27 and greater than or equal to 0.10, such as less than or equal to 0.26 and greater than or equal to 0.10, less than or equal to 0.25 and greater than or equal to 0.10, less than or equal to 0.24 and greater than or equal to 0.10, less than or equal to 0.23 and greater than or equal to 0.10, less than or equal to 0.22 and greater than or equal to 0.10, less than or equal to 0.21 and greater than or equal to 0.10, or less than or equal to 0.20 and greater than or equal to 0.10.

FIG. 7 shows a linear regression analysis of the predicted CoF plotted on the y-axis against the experimental CoF on the x-axis. From this analysis, it was found that the experimental CoF correlates to the predicted CoF according to the following equation:

CoFₑₓₚ=1.676*CoFₛᵢₘ−2.403*10⁻²

As shown in FIG. 6, the r² for this equation is 0.948

As disclosed hereinabove, in one or more embodiments the fluorinated polyimides having the above properties—such as the CED, T_{g}, fluorine density, and CoF—are soluble in conventional industrial solvents. Conventional solvents include, but are not limited to, acetates, such as alkyl acetates, dioxane, tetrahydrofuran (THF), dioxolane, dimethylacetamide, and N-methyl-2-pyrrolidone. By being soluble in solvents, the fluorinated polyimide containing coating can easily be applied to glass articles by conventional coating methods, such as spray coating, dip coating, spin coating, or coating with an applicator, such as a brush or the like. In embodiments, the solvent is n-propyl acetate having a Hildebrand solubility less than or equal to 8.6 calories per cubic centimeter ((cal/cm³)^{1/2}), such as less than or equal to 8.0 (cal/cm³)^{1/2}, less than or equal to 7.5 (cal/cm³)^{1/2}, less than or equal to 7.0 (cal/cm³)^{1/2}, less than or equal to 6.5 (cal/cm³)^{1/2}, less than or equal to 6.0 (cal/cm³)^{1/2}, less than or equal to 5.5 (cal/cm³)^{1/2}, less than or equal to 5.0 (cal/cm³)^{1/2}, less than or equal to 4.5 (cal/cm³)^{1/2}, less than or equal to 4.0 (cal/cm³)^{1/2}, less than or equal to 3.5 (cal/cm³)^{1/2}, less than or equal to 3.0 (cal/cm³)^{1/2}, or less than or equal to 2.5 (cal/cm³)^{1/2}.

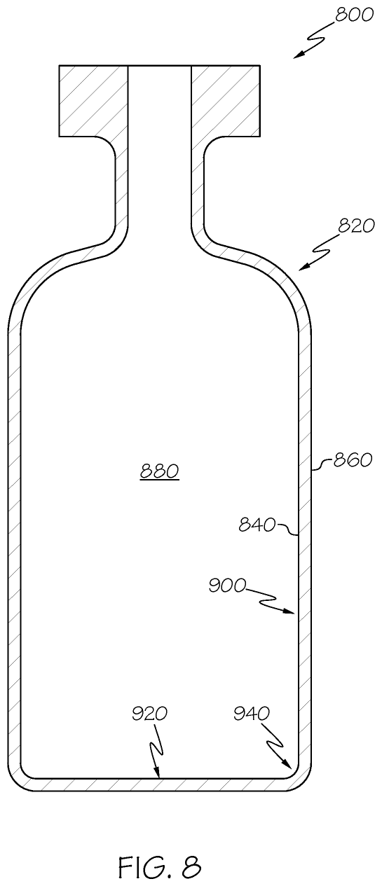

According to embodiments, methods for coating glass articles according to embodiments disclosed and described herein include methods for coating glass containers. Referring to FIG. 8 by way of example, a glass container, such as a glass container for storing a pharmaceutical composition, is schematically depicted in cross section. The glass container 800 generally comprises a glass body 820. The glass body 820 extends between an interior surface 840 and an exterior surface 860 and generally encloses an interior volume 880. In the embodiment of the glass container 800 shown in FIG. 8, the glass body 820 generally comprises a wall portion 900 and a floor portion 920. The wall portions 900 and the floor portion 920 may generally have a thickness in a range from about 0.5 mm to about 3.0 mm. The wall portion 900 transitions into the floor portion 920 through a heel portion 940. According to embodiments, the interior surface 840 and floor portion 920 are uncoated and, as such, the contents stored in the interior volume 880 of the glass container 800 are in direct contact with the glass from which the glass container 800 is formed. However, in embodiments, the interior surface 840 and floor portion 820 are coated. While the glass container 800 is depicted in FIG. 8 as having a specific shape form (i.e., a vial), it should be understood that the glass container 800 may have other shape forms, including, without limitation, vacutainers, cartridges, syringes, syringe barrels, ampoules, bottles, flasks, phials, tubes, beakers, or the like. According to methods disclosed and described herein comprise applying a coating containing fluorinated polyimides disclosed herein to at least a portion of the exterior surface 860 of the glass container 800. In embodiments, the entire exterior surface 860 of the glass container 800 is coated with a coating comprising fluorinated polyimides as disclosed herein.

What is claimed is:

1. A method for coating a glass article comprising:
obtaining a glass article;
selecting a coating comprising a fluorinated polyimide, the fluorinated polyimide having:
a cohesive energy density less than or equal to 300 KJ/mol; and
a glass transition temperature (T_{g}) less than or equal to 625 K; and
coating the glass article with the selected coating comprising the fluorinated polyimide.

2. The method for coating a glass article of claim 1, wherein the fluorinated polyimide has a fluorine density less than or equal to 0.10.

3. The method for coating a glass article of claim 2, wherein a coefficient of friction of the coating comprising the fluorinated polyimide meets the following inequality:
0.27≥0.111*CED−4.319*10⁻⁴*CED²+5.594*CED³+1.135*f_{F}−5.859*10⁻²*T_{g}+5.314*T_{g}²+6.823, where
CED is a cohesive energy density of the fluorinated polyimide coating,
f_{F} is a number of fluorine atoms in a polymer repeat unit divided by a total number of heavy atoms in the polymer repeat unit, and
T_{g} is a glass transition temperature of the fluorinated polyimide coating.

4. The method for coating a glass article of claim 1, wherein the fluorinated polyimide has a fluorine density of greater than 0.10 and less than or equal to 0.15, and the fluorinated polyimide has a T_{g} less than or equal to 575 K.

5. The method for coating a glass article of claim 4, wherein a coefficient of friction of the coating comprising the fluorinated polyimide meets the following inequality:
0.27≥−9.017*10⁻³*CED+1.941*10⁻⁵*CED²−4.773*f_{F}+28.477*f_{F}²+2.041*10⁻³*T_{g}−2.351*10⁻⁶*T_{g}²+0.913, where
CED is a cohesive energy density of the fluorinated polyimide coating,
f_{F} is a number of fluorine atoms in a polymer repeat unit divided by a total number of heavy atoms in the polymer repeat unit, and
T_{g} is a glass transition temperature of the fluorinated polyimide coating.

6. The method for coating a glass article of claim 1, wherein the fluorinated polyimide coating comprises a polymer with a fluorine density of greater than 0.15, and the fluorinated polyimide coating has a T_{g} less than or equal to 500 K.

7. The method for coating a glass article of claim 6, wherein a coefficient of friction of the fluorinated polyimide coating meets the following inequality:
0.27≥−5.09*10⁻⁴*CED−0.463*f_{F}+4.683*10⁻⁵*T_{g}+0.373, where
CED is a cohesive energy density of the fluorinated polyimide coating,
f_{F} is a number of fluorine atoms in a polymer repeat unit divided by a total number of heavy atoms in the polymer repeat unit, and
T_{g} is a glass transition temperature of the fluorinated polyimide coating.

8. The method for coating a glass article of claim 1, wherein the fluorinated polyimide has a solubility of less than or equal to 8.6 (cal/cm³)^{1/2}.

9. The method for coating a glass article of claim 1, wherein the glass article is a glass pharmaceutical container having an interior surface and an exterior surface.

10. The method for coating a glass article of claim 9, wherein the step of coating the glass article with the selected coating comprising the fluorinated polyimide comprises coating at least a portion of the exterior surface of the glass pharmaceutical container.

11. The method for coating a glass article of claim 1, wherein selecting a coating comprising a fluorinated polyimide comprises:
choosing an original polymer chemistry;
modifying the original polymer chemistry with functional groups to generate a multitude of modified polymer chemistries;
determining the cohesive energy density (CED) of each of the multitude of modified polymer chemistries;
determining the T_{g} of each of the multitude of modified polymer chemistries;
choosing a group of designated polymer chemistries from the multitude of modified polymer chemistries, wherein each polymer chemistry in the designated group of polymer chemistries has a CED that is less than or equal to the CED of the original polymer chemistry, and each polymer chemistry in the designated group of polymer chemistries has a T_{g} that is less than the T_{g} of the original polymer chemistry;
determining the coefficient of friction of each polymer chemistry within the designated group of polymer chemistries; and
choosing a selected polymer chemistry from the designated group of polymer chemistries, wherein the selected polymer chemistry has a coefficient of friction that is less than a coefficient of friction of the original polymer chemistry.

12. The method for coating a glass article of claim 11, wherein modifying the original polymer chemistry comprises:
identifying a backbone structure of the original polymer chemistry, wherein the backbone structure comprises one or more attachment sites;
providing a set of side chain structures; and
attaching each side chain structure in the set of side chain structures to the one or more attachment sites of the backbone structure in a combinatorial fashion.

13. The method for coating a glass article of claim 12, wherein the backbone structure incorporates a dianhydride monomer structure.

14. The method for coating a glass article of claim 13, wherein the dianhydride monomer structure comprises one or more member selected from the group consisting of:

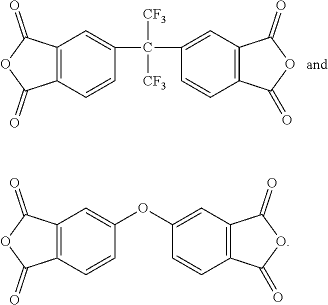 [SMILES: O=C1OC(=O)c2cc(C(c3ccc4c(c3)C(=O)OC4=O)(C(F)(F)F)C(F)(F)F)ccc21 ; "and" ; O=C1OC(=O)c2cc(Oc3ccc4c(c3)C(=O)OC4=O)ccc21]

15. The method for coating a glass article of claim 12, wherein the set of side chain structures comprises one or more diamines.

16. The method for coating a glass article of claim 15, wherein the one or more diamines comprises one or more member selected from the group consisting of:

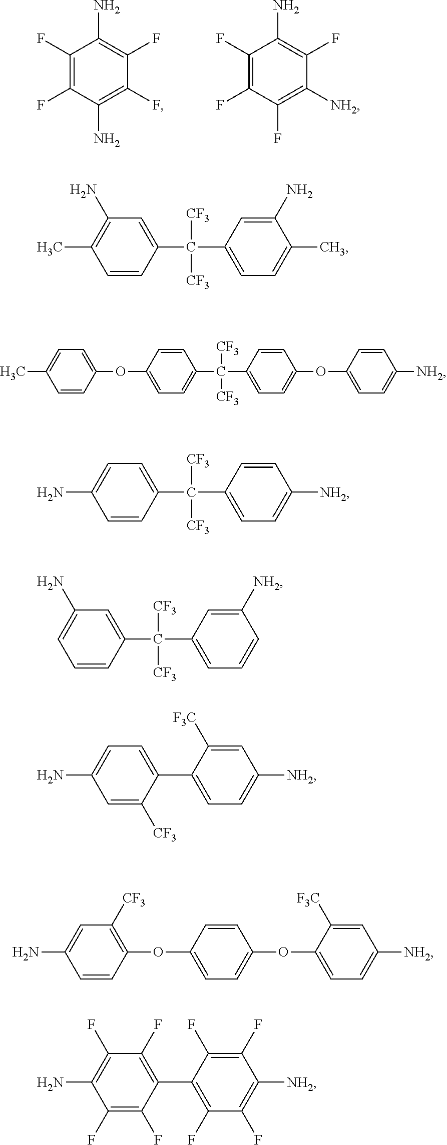

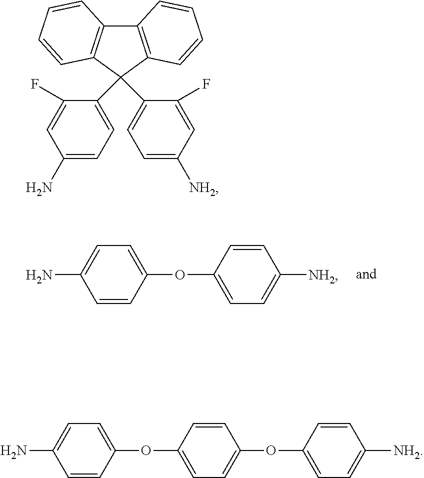 [SMILES: Nc1ccc(C2(c3ccc(N)cc3F)c3ccccc3-c3ccccc32)c(F)c1 ; Nc1ccc(Oc2ccc(N)cc2)cc1 ; Nc1ccc(Oc2ccc(Oc3ccc(N)cc3)cc2)cc1]

17. The method according to claim 12, wherein the backbone structure of the original polymer chemistry is modified before attaching each side chain structure in the set of side chain structures to the one or more attachment sites of the backbone structure in a combinatorial fashion.

18. The method according to claim 17, wherein the backbone structure of the original polymer chemistry is modified by extending the backbone structure, contracting the backbone structure, or switching chemical groups of the backbone structure.

19. A method for forming a fluorinated polyimide having a low coefficient of friction comprising:
choosing an original polymer chemistry;
modifying the original polymer chemistry with functional groups to generate a multitude of modified polymer chemistries;
determining the cohesive energy density (CED) of each of the multitude of modified polymer chemistries;
determining the T_{g} of each of the multitude of modified polymer chemistries;
choosing a group of designated polymer chemistries from the multitude of modified polymer chemistries, wherein each polymer chemistry in the designated group of polymer chemistries has a CED that is less than or equal to the CED of the original polymer chemistry, and each polymer chemistry in the designated group of polymer chemistries has a T_{g} that is less than the T_{g} of the original polymer chemistry;
determining the coefficient of friction of each polymer chemistry within the designated group of polymer chemistries; and
forming selected polymer chemistry from the designated group of polymer chemistries, wherein the selected polymer chemistry has the lowest coefficient of friction of the designated group of polymer chemistries.

20. The method for forming a fluorinated polyimide having a low coefficient of friction of claim 19, wherein determining the coefficient of friction of each polymer chemistry within the designated group of polymer chemistries uses the following formula:
CoF=0.111*CED−4.319*10⁻⁴*CED²+5.594*CED³+1.135*f_{F}−5.859*10⁻²*T_{g}+5.314*T_{g}²+6.823, where
CED is a cohesive energy density of the fluorinated polyimide coating,
f_{F} is a number of fluorine atoms in a polymer repeat unit divided by a total number of heavy atoms in the polymer repeat unit and is less than 0.1, and
T_{g} is a glass transition temperature of the fluorinated polyimide coating.

21. The method for forming a fluorinated polyimide having a low coefficient of friction of claim 19, wherein determining the coefficient of friction of each polymer chemistry within the designated group of polymer chemistries uses following formula:
CoF=−9.017*10⁻³*CED+1.941*10⁻⁵*CED²−4.773*f_{F}+28.477*f_{F}²+2.041*10⁻³*T_{g}−2.351*10⁻⁶*T_{g}²+0.913, where
CED is a cohesive energy density of the fluorinated polyimide coating,
f_{F} is a number of fluorine atoms in a polymer repeat unit divided by a total number of heavy atoms in the polymer repeat unit and f_{F} is greater than 0.1 and less than 0.15, and
T_{g} is a glass transition temperature of the fluorinated polyimide coating.

22. The method for forming a fluorinated polyimide having a low coefficient of friction of claim 19, wherein determining the coefficient of friction of each polymer chemistry within the designated group of polymer chemistries uses the following formula:
CoF=−5.09*10⁻⁴*CED−0.463*f_{F}+4.683*10⁻⁵*T_{g}+0.373, where
CED is a cohesive energy density of the fluorinated polyimide coating,
f_{F} is a number of fluorine atoms in a polymer repeat unit divided by a total number of heavy atoms in the polymer repeat unit and f_{F} is greater than 0.15, and
T_{g} is a glass transition temperature of the fluorinated polyimide coating.
